(19) United States
(12) Patent Application Publication
(10) Pub. No.: US 2019/0092447 A1
(43) Pub. Date: Mar. 28, 2019

(54) MULTIROTOR AIRCRAFT

(71) Applicant: AUTEL ROBOTICS CO., LTD., Shenzhen (CN)

(72) Inventors: Marc SCHWARZBACH, Shenzhen (CN); Jian WANG, Shenzhen (CN); Thomas RAFFLER, Shenzhen (CN)

(21) Appl. No.: 16/051,726

(22) Filed: Aug. 1, 2018

Related U.S. Application Data
(63) Continuation of application No. PCT/CN2016/073658, filed on Feb. 5, 2016.

(51) Int. Cl. B64C 1/28; B64C 27/08; B64C 39/02

(52) U.S. Cl. CPC B64C 1/28; B64C 27/08; B64C 39/024; B64C 2201/024; B64C 2201/146; B64C 2201/088; B64C 2201/108; B64C 2201/127; B64C 2201/165; B64C 2201/042

(57) ABSTRACT

A multirotor aircraft is provided. The multirotor aircraft comprises a body comprising a main body and a camera assembly with a camera coupled to the main body; a frame connected to the body, comprising a multirotor propulsion system; and a drive system coupled with the body and the frame, for driving the body to rotate against the frame. With the multirotor aircraft, full unobstructed 360° yaw field of view of the camera in the upper or lower hemisphere can be obtained and the camera is in a safe position at takeoff and landing.

### TECHNICAL FIELD OF THE INVENTION

The present invention relates generally to an unmanned aerial vehicle, and in particular to a multirotor aircraft.

### BACKGROUND OF THE INVENTION

To allow unobstructed 360 degree view, either the camera system of the multirotor aircraft is moved below the level of the landing structure or the landing structure is moved over the level of camera view. This is performed by a moving frame, or a retractable landing gear. However, in these two cases, the camera is not safe at takeoff or landing, and is hard to reach, especially when the change of the lens is desired. Further, the angle for filming is also limited in these two cases.

Without one of these methods, the whole fight system has to be rotated, which limits dynamic and the possibility to control the camera independently of flight control of the platform. A case of mounting the camera looking to the front allows for views up and down, while still requires yaw of the whole system for camera yaw.

### SUMMARY OF THE INVENTION

A multirotor aircraft is provided, so that the camera is safe at takeoff and landing, and has more angles to film to and is easy to reach.

According to one aspect of the present invention, a multirotor aircraft is provided. The multirotor aircraft comprises: a body comprising a main body and a camera assembly with a camera coupled to the main body; a frame connected to the body, comprising a multirotor propulsion system; and a drive system coupled with the body and the frame, for driving the body to rotate against the frame.

Preferably, the body and the frame is connected by a bearing.

Preferably, the frame comprises a shaft and four arms, and two of the four arms are connected to one end of the shaft and the other two of the four arms are connected to the other end of the shaft.

Preferably, the multirotor propulsion system comprises four actuator assemblies, wherein each of the four actuator assemblies is mounted on the end of each arm which is far away from the shaft of the frame.

Preferably, the multirotor propulsion system comprises eight actuator assemblies, wherein the end of each arm which is far away from the shaft of the frame is mounted with two actuator assemblies.

Preferably, the drive system comprises an actuator and a transmission device coupled with the actuator.

Preferably, the drive system is used to drive a part of the body to rotate against the frame, wherein the part of the body comprises the camera assembly.

Preferably, the camera assembly is disposed on the top of the main body.

Preferably, the camera assembly is configured to allow for continuous compensation of body rotation or to work in three rotation modes separately with switching motion.

Preferably, the drive system comprises a rotary angle sensor for sensing the angle between the body and the frame.

Preferably, the rotary angle sensor comprises a variable resistor, an optical system or two inertial measurement systems disposed on the body and the frame respectively.

Preferably, the multirotor aircraft comprises a shock absorbing mechanism coupled with the drive system.

Preferably, the shock absorbing mechanism comprises a coupling.

Preferably, the body further comprises landing structs coupled to the bottom of the main body.

Preferably, the multirotor aircraft further comprises a controller electrically connected to the drive system and configured to control the drive system to drive the body to rotate against the frame automatically or according to a user command.

Preferably, the controller is further configured to initiate the rotation of the body when a predetermined latitude is reached by the multirotor aircraft.

Preferably, the controller is further configured to keep the body in a camera up position at takeoff and landing.

Preferably, the controller is further electrically connected to the camera assembly and further configured to control the camera assembly to stabilize and/or point the camera automatically or according to a user command.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an isometric view of a multirotor aircraft in accordance with an embodiment of the present invention;

FIG. 2 illustrates a side view of the multirotor aircraft of FIG. 1 with the body rotated to a camera up position, in accordance with an embodiment of the present invention;

FIG. 3 illustrates a top view of the multirotor aircraft of FIG. 1 with the body rotated to a camera front position, in accordance with an embodiment of the present invention;

FIG. 4 illustrates a side view of the multirotor aircraft of FIG. 1 with the body rotated to a camera down position, in accordance with an embodiment of the present invention;

FIG. 5 illustrates an isometric view of a frame of the multirotor aircraft of FIG. 1 with four actuator assemblies, in accordance with an embodiment of the present invention;

FIG. 6 illustrates an isometric view of a frame of the multirotor aircraft of FIG. 1 with eight actuator assemblies, in accordance with an embodiment of the present invention; and

FIG. 7 illustrates an isometric view of a body of the multirotor aircraft of FIG. 1, in accordance with an embodiment of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known method, procedures, components and circuits have not been described in detail so as not to obscure the present invention.

Embodiments of the present invention provide a multirotor aircraft. By mounting the camera system to a rotating body, the camera is safe at takeoff and landing, has more angles to film to (360° both up and down and forward) and is easy to reach. All benefits of existing systems allowing 360-degree view in the horizontal plane are also covered.

As used herein, the terms ‘upper’, ‘lower’, ‘vertical’, ‘horizontal’ and other similar position-indicating terms are used with reference to the multirotor aircraft in its normal operation mode, and should not be considered limiting.

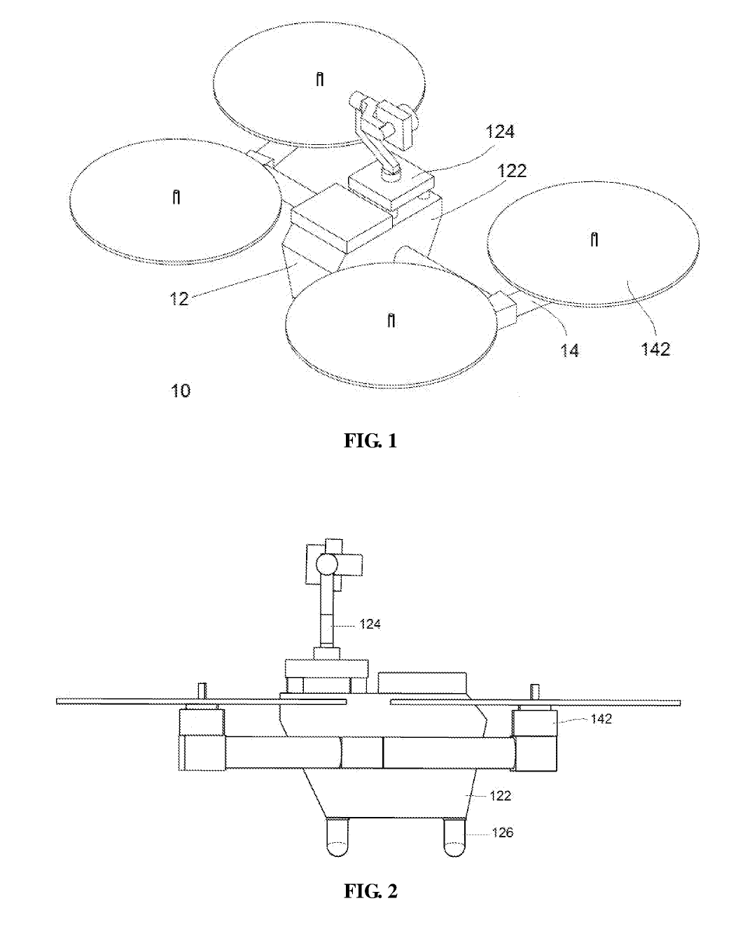

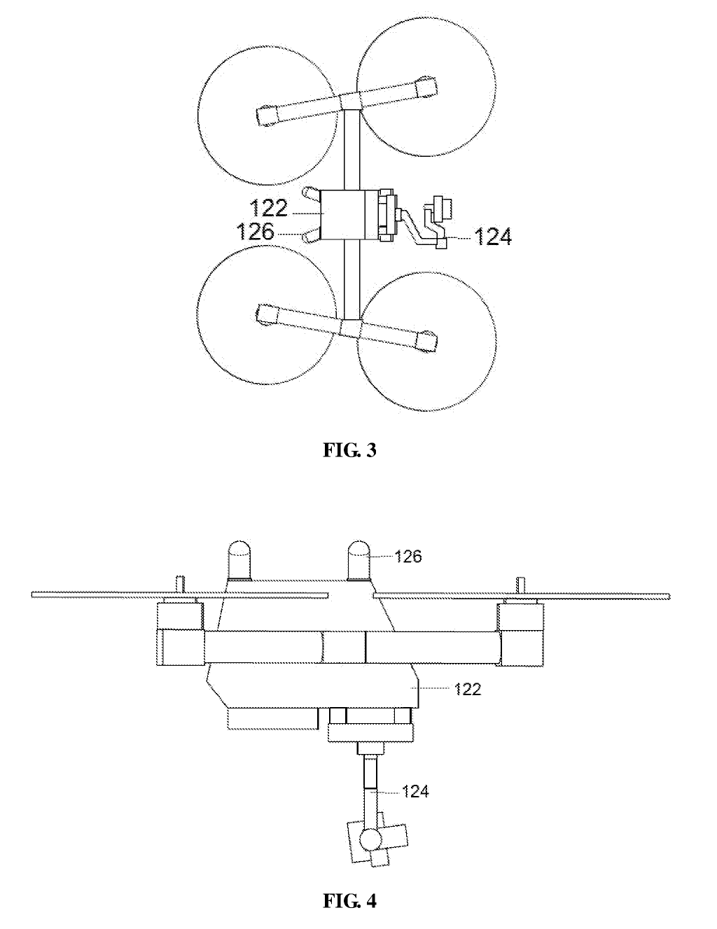

FIG. 1 illustrates an isometric view of a multirotor aircraft in accordance with an embodiment of the present invention. As illustrated in FIG. 1, the multirotor aircraft 10 may comprise a body 12 and a frame 14 connected to the body 12. The body 12 may comprise a main body 122 and a camera assembly with a camera 124 coupled to the main body 122. The frame 14 may comprise a multirotor propulsion system 142 for propelling the aircraft. The multirotor aircraft 10 may further comprise a drive system coupled with the body 12 and the frame 14, not shown, for driving the body 12 to rotate against the frame 14. In some embodiments, the body 12 can be rotated against the frame 14 by the driving system by at least 180 degree. For example, the body 12 may be rotated to a camera up position, a camera front position or a camera down position, as illustrated by FIG. 2-4 respectively. Of course, the body 12 may be rotated to other positions or angles. As a result, more angles for filming can be attained.

The drive system may comprise an actuator and a transmission device coupled with the actuator. In particular, the actuator may be coupled with the body 12 and the transmission device may be coupled with the frame 14 or vice versa, so that the actuator may drive, through the transmission device, the body 12 to rotate against the frame 14. The drive system may comprise a gear drive system, a belt drive system or a brushless direct drive system. Take the gear drive system for example, it may comprise an actuator coupled to the frame 14 and a gear coupled to the body 12 or vice versa, and the actuator is used to drive the gear, so as to drive the body 12 to rotate against the frame 14. The other two drive systems may be configured in a similar way. The actuator may comprise electric motor, mechanical actuator, hydraulic actuator, pneumatic actuator, or the like. Electric motors may include magnetic, electrostatic or piezoelectric motors.

The drive system may further comprise a rotary angle sensor, for sensing the angle between the body 12 and the frame 14. The rotary angle sensor may comprise a variable resistor, an optical system or two inertial measurement systems disposed on the body and the frame respectively. The sensed angle between the body 12 and the frame 14 may be used for flight control and/or camera assembly control.

In some embodiments, the body 12 and the frame 14 may be connected by a bearing. For example, as illustrated in FIG. 1, the body 12 and the frame 14 may be connected by two bearings. In particular, the main body 122 may comprise two holes disposed on two opposite side faces, two bearings may be mounted in these two holes, and a shaft of the frame 14 may go through the two bearings. The locations of the two bearings as illustrated in FIG. 1 are exemplary and can be any other suitable locations. In other examples, the body 12 and the frame 14 may be connected by less or more bearings. The bearing can be a rolling bearing or a sliding bearing.

FIG. 5 illustrates an isometric view of a frame of the multirotor aircraft of FIG. 1 with four actuator assemblies, in accordance with an embodiment of the present invention. As illustrated in FIG. 5, the frame 14 may comprise a lateral 144 and four arms, and two of the four arms may be connected to one end of the shaft 144 and the other two of the four arms may be connected to the other end of the shaft 144. Further, the multirotor propulsion system 142 may comprise four actuator assemblies 142a-d, and each of the four actuator assemblies 142a-d may be mounted on the end of each arm which is far away from the shaft 144. In particular, each of the four actuator assemblies may be removably coupled to the top surface of the end of each arm which is far away from the shaft 144, as illustrated in FIG. 5, or each of the four actuator assemblies may be removably coupled to the bottom surface of the end of each arm which is far away from the shaft.

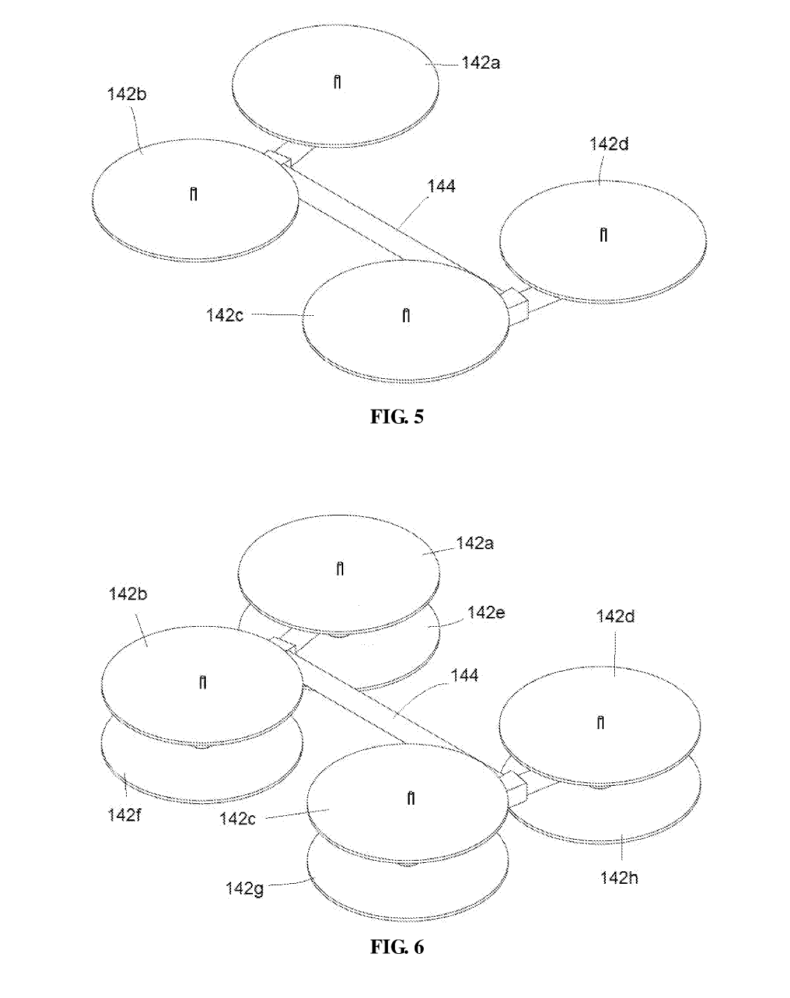

FIG. 6 illustrates a side view of a frame of the multirotor aircraft of FIG. 1 with eight actuator assemblies, in accordance with an embodiment of the present invention. As illustrated in FIG. 6, the multirotor propulsion system 142 may comprise eight actuator assemblies 142a-h, and the end of each arm which is far away from the shaft 144 is mounted with two of the eight actuator assemblies. In particular, one actuator assembly may be removably coupled with the top surface of the end of each arm which is far away from the shaft 144 and the other actuator assembly may be removably coupled with the bottom surface of the same end. Through the implementation of a redundant setup using eight actuator assemblies, the safety of the multirotor aircraft can be improved.

In various embodiments, the actuator assembly may comprise an actuator and a rotor wing or blade coupled to the actuator, and the actuator is used to drive the rotor wing or blade. As discussed above, the actuator may comprise electric motor, mechanical actuator, hydraulic actuator, pneumatic actuator, or the like. Electric motors may include magnetic, electrostatic or piezoelectric motors.

In some embodiments, the frame 14 may have an asymmetric shape. In one example, the shaft and each of the front two arms of the frame 14 may form an obtuse angle, and the shaft and each of the back two arms of the frame 14 may form an acute angle. In another example, the shaft and each of the front two arms of the frame 14 may form an obtuse angle, and the shaft and each of the back two arms of the frame 14 may form a right angle or a smaller obtuse angle. In this way, a better view angle for the camera can be obtained.

In some embodiments, the frame 14 may have an asymmetric shape. In one example, the shaft and each of the four aims of the frame 14 may form a right angle. In another example, the shaft and each of the four arms of the frame 14 may form the same acute angle or obtuse angle.

In some embodiment, each arm of the frame 14 may be removably coupled to the shaft of the frame 14. For example, during assembly of the frame 14, each arm may be removably coupled to the shaft via fasteners such as screw, bolt, buckle, clamp, clasp, latch, hook, nail, pin, strap, cable, or the like. Such removable coupling can be used to facilitate maintenance of the multirotor aircraft. When maintenance is required, each arm may be decoupled from the shaft. In another embodiment, each arm and the shaft of the frame may be welded or otherwise permanently held together.

In various embodiments, any individual or combination of the components that form the frame 14 can be manufactured using any suitable technique such injection molding, additive manufacturing (3-D printing) techniques, or the like. For example, each arm and the shaft of the frame 14 can be manufactured individually and welded, fastened or otherwise combined to form the frame. As another example, the two arms connected to one end of the shaft can be integrally manufactured as one piece, and the other two arms connected to the other end of the shaft can be integrally manufactured as one piece. Then the two integrally manufactured pieces and the shaft 141 can be combined (via welding, fastener, etc.) to from the frame 14. As yet another example, the frame 14 can be integrally manufactured, for example, using injection molding or additive manufacturing techniques.

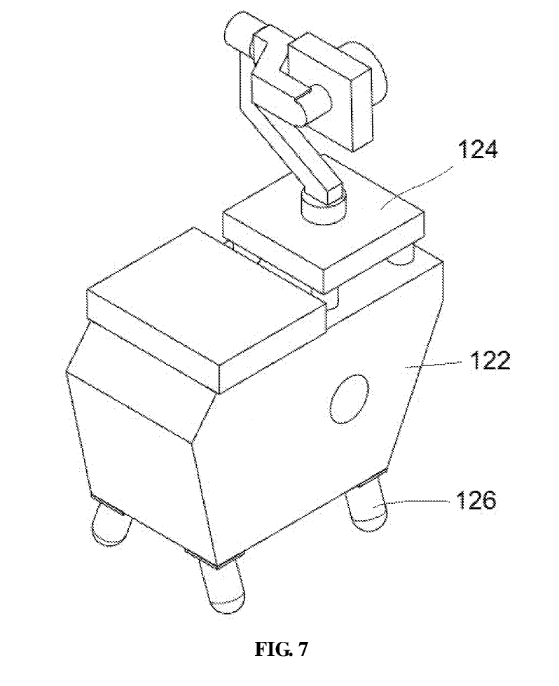

FIG. 7 illustrates an isometric view of a body of the multirotor aircraft of FIG. 1, in accordance with an embodiment of the present invention. As illustrated in FIG. 7, the camera assembly 124 may be disposed on the top of the main body 122. In particular, the camera assembly 124 may be removably coupled to the front part of the top surface of the main body 122. Of cause, the camera assembly 124 can also be disposed in any other suitable place. The camera assembly 124 may be designed either to be able to allow for continuous compensation of body rotation or to work in three rotation modes separately with switching motion.

In some embodiments, the body may further comprise landing structs 126 coupled to the bottom of the main body 122, in order to protect the main body 122 at landing. The landing structs 106 may have the shape as shown in FIG. 7 or any other suitable shape. In FIG. 7, there are four landing structs, however, other number of landing structs is possible, for example one, two three or more than four landing structs. The landing structs 126 may be removably coupled to the bottom of the main body 122 in any suitable configuration.

In some embodiments, some parts of the body may be fixed to the frame and other parts of the body may be rotated against the frame by the drive system. The other parts of the body may comprise the camera assembly, or the camera assembly only can be rotated against the frame by the drive system.

In some embodiments, the multirotor may further comprise a damping system. The damping system may be used to optimize the damping when the body is in the camera up position. As an example, the damping system may comprise a damper. The damper may be pushed from inside the body to the base of the camera assembly 124 to support the camera assembly 124, when the body is in the camera up position. The pushing of the damper may be actuated by an additional actuator or may be actuated by the drive system through a mechanism connected to the drive system.

In some embodiments, the multirotor aircraft may further comprise a shock absorbing system for absorbing the shock loads to the drive system, e.g. in case of a hard landing. As an example, the shock absorbing system may comprise a coupling connected to the drive system.

The multirotor aircraft may further comprise a controller configured to control the drive system to drive the body to rotate against the frame automatically or according to a user command. The controller may be electrically connected to the drive system. In particular, the controller may be configured to control the drive system to keep the body in the camera up position as shown in FIG. 2 at takeoff and landing. By keeping the body in the camera up position at takeoff and landing, the camera is in a safe position at takeoff and landing and is easy to reach on the ground. The controller may further be configured to control the drive system to initiate the rotation of the body when a predetermined latitude is reached by the multirotor aircraft, if filming to the front or down is desired. In flight, the controller may be configured to control the drive system to rotate the body to a desired angle or position by user command or automatically, for example to the camera front position or camera down position or any other desired position or angle. Therefore, full unobstructed 360° yaw field of view of the camera in the upper or lower hemisphere can be obtained. The controller may also be electrically connected to the camera assembly and configured to control the camera assembly to stabilize and/or point the camera as desired.

The body may be mounted with one or more electrical component adapted to control various aspects of the operation of the multirotor aircraft. As used herein, the term ‘electrical component’ refers to any component that provides, uses or transmits electricity. Such electrical components can include an energy source (e.g., battery), flight control or navigation module, GPS module (e.g., GPS receiver or transceivers), inertial measurement unit (IMU) module, communication module (e.g., wireless transceiver), electronic speed control (ESC) module adapted to control an actuator (e.g., electric motor), actuator(s) such as an electric motor used to actuate a propeller of the multirotor aircraft, electrical wirings and connectors, and the like. In some embodiments, some of the electrical components may be located on an integrated electrical unit such as a circuit board or module. In some embodiments, some of the electrical components may be located on one or more circuit modules. Each circuit module can include one or more electrical components. For example, the circuit module can include the flight control module that includes one or more processors (such as implemented by a field-programmable gate array (FPGA)) for controlling key operation of the multirotor aircraft. As another example, the same or a different circuit module can also include an IMU module for measuring the velocity, orientation and gravitational forces of the multirotor aircraft. The IMU module can include one or more accelerometers and/or gyroscopes. As another example, the same or a different circuit module can also include a communication module for remotely communicating with a remote control device. For example, the communication module can include a wireless (e.g., radio) transceiver. The communication module can be provided with button or buttons and corresponding indicator light that is spaced apart from the buttons. The buttons and the indicator light may be used for facilitating communication between the multirotor aircraft and a remote control device. For example, the buttons may be used to adjust the frequency channel used by the multirotor aircraft and the indicator light can be used to indicate the success and/or failure of the establishment of a communication channel between the multirotor aircraft and the remote control device.

The fight control module is typically a key component or ‘brain’ of a multirotor aircraft. For example, the flight control module can be configured to estimate the current velocity, orientation and/or position of the multirotor aircraft based on data obtained from visual sensors (e.g., cameras), IMU, GPS receiver and/or other sensors, perform path planning, provide control signals to actuators to implement navigational control and the like. As another example, the flight control module can be configured to issue control signals to adjust the state of the multirotor aircraft based on remotely received control signals.

The multirotor aircraft according to various embodiments of the present invention can provide the following advantages: full unobstructed 360° yaw field of view of the camera in the upper or lower hemisphere: camera in a safe position at takeoff and landing; camera easy to reach on the ground in case of e.g. lens change; possibility to extend to a eight rotor system; only one axis moving, which increases robustness, e.g. compared with the existing multirotor aircraft with a moving frame or a retractable landing gear.

While preferred embodiments of the present invention have been shown and described herein, it will be obvious to those skilled in the art that such embodiments are provided by way of example only. Numerous variations, changes, and substitutions will now occur to those skilled in the art without departing from the spirit of the present invention. It should be understood that various alternatives to the embodiments of the invention described herein may be employed in practicing the invention. It is intended that the following claims define the scope of the invention and that methods and structures within the scope of these claims and their equivalents are covered hereby.

1. A multirotor aircraft, comprising:
a body comprising a main body and a camera assembly with a camera coupled to the main body;
a frame connected to the body, comprising a multirotor propulsion system; and
a drive system coupled with the body and the frame, for driving the body to rotate against the frame.

2. The multirotor aircraft of claim 1, wherein,
the body and the frame are connected by a bearing.

3. The multirotor aircraft of claim 1, wherein,
the frame comprises a shaft and four arms, and two of the four arms are connected to one end of the shaft and the other two of the four arms are connected to the other end of the shaft.

4. The multirotor aircraft of claim 3, wherein
the multirotor propulsion system comprises four actuator assemblies, wherein each of the four actuator assemblies is mounted on the end of each arm which is far away from the shaft of the frame.

5. The multirotor aircraft of claim 3, wherein
the multirotor propulsion system comprises eight actuator assemblies, wherein the end of each arm which is far away from the shaft of the frame is mounted with two actuator assemblies.

6. The multirotor aircraft of claim 1, wherein,
the drive system comprises an actuator and a transmission device coupled with the actuator.

7. The multirotor aircraft of claim 1, wherein,
the drive system is used to drive a part of the body to rotate against the frame, wherein the part of the body comprises the camera assembly.

8. The multirotor aircraft of claim 1, wherein,
the camera assembly is disposed on the top of the main body.

9. The multirotor aircraft of claim 1, wherein,
the camera assembly is configured to allow for continuous compensation of body rotation or to work in three rotation modes separately with switching motion.

10. The multirotor aircraft of claim 1, wherein,
the drive system comprises a rotary angle sensor for sensing the angle between the body and the frame.

11. The multirotor aircraft of claim 10, wherein,
the rotary angle sensor comprises a variable resistor, an optical system or two inertial measurement systems disposed on the body and the frame respectively.

12. The multirotor aircraft of claim 1, further comprising:
a shock absorbing mechanism coupled with the drive system.

13. The multirotor aircraft of claim 12, wherein,
the shock absorbing mechanism comprises a coupling.

14. The multirotor aircraft of claim 1, wherein,
the body further comprises landing structs coupled to the bottom of the main body.

15. The multirotor aircraft of claim 1, further comprising:
a controller electrically connected to the drive system and configured to control the drive system to drive the body to rotate against the frame automatically or according to a user command.

16. The multirotor aircraft of claim 15, wherein,
the controller is further configured to initiate the rotation of the body when a predetermined latitude is reached by the multirotor aircraft.

17. The multirotor aircraft of claim 15, wherein,
the controller is further configured to keep the body in a camera up position at takeoff and landing.

18. The multirotor aircraft of claim 15, wherein,
the controller is further electrically connected to the camera assembly and further configured to control the camera assembly to stabilize and/or point the camera automatically or according to a user command.

19. The multirotor aircraft of claim 6, wherein,
the drive system is used to drive a part of the body to rotate against the frame, wherein the part of the body comprises the camera assembly.

20. The multirotor aircraft of claim 8, wherein,
the camera assembly is configured to allow for continuous compensation of body rotation or to work in three rotation modes separately with switching motion.
